(19) United States
(12) Patent Application Publication
(10) Pub. No.: US 2010/0304713 A1
(43) Pub. Date: Dec. 2, 2010

(54) Technique for restricting access to a wireless communication service

(76) Inventors: Penny Lynne Bright, Naperville, IL (US); Keith Albert Mack, Aurora, IL (US); Terrence M O'Leary, Aurora, IL (US); Hugh D Roche, Naperville, IL (US)

Correspondence Address: Docket Administrator - Room 3D-201E;Alcatel-Lucent USA Inc., 600-700 Mountain Avenue, Murray Hill, NJ, 07974, US

(21) Appl. No.: 12/455,460

(22) Filed: Jun. 1, 2009

(51) Int. Cl. H04M 1/66

(52) U.S. Cl. 455/411

(57) ABSTRACT

In providing a wireless communication service of a selected type, a user of a mobile communication device may attempt to access the selected type of service despite his/her subscription to a different type of service. In processing the device's request for accessing the selected type of service, an authentication vector is retrieved based on information identifying the device in the request. The access to the selected type of service may be denied after it is determined that a presentation of the authentication vector does not conform to the selected type of service.

### FIELD OF THE INVENTION

The invention relates to a technique for providing a wireless communication service and, more particularly, to a technique for controlling access to a wireless communication service.

### BACKGROUND OF THE INVENTION

This section introduces aspects that may help facilitate a better understanding of the invention. Accordingly, the statements of this section are to be read in this light and are not to be understood as admissions about what is prior art or what is not prior art.

Wireless communication services provisioned according to the global system for mobile communications (GSM) and universal mobile telecommunication system (UMTS) standards are common nowadays. UMTSs are so-called “third generation (3G)” mobile communication systems, which gradually are supplanting “second generation (2G)” systems, e.g., GSM systems, used in many wireless service areas. During this migration from 2G mobile communication technology to 3G technology, many wireless service providers provide both the GSM and UMTS services in the same service area.

A UMTS service generally is a premium service relative to a GSM service. The UMTS service usually affords voice and data communications of a higher quality and capacity than the GSM service. The UMTS service also can provide video telephony (e.g., video conferencing) and high CD quality sound on a 3G mobile communication device. In addition, it can provide better location information and thus more sophisticated location-based services than the GSM service.

Other differences between the UMTS service and GSM service include their service security. The GSM service security involves a well known unilateral authentication process where one or more GSM authentication vectors are used to authenticate a mobile communication device towards a GSM network. On the other hand, the UMTS service security involves a well known bilateral authentication process where one or more authentication vectors are used not only to authenticate a mobile communication device towards a UMTS network, but also the UMTS network towards the device.

### BRIEF SUMMARY

The invention is directed to a technique for restricting a user, e.g., from accessing a selected type of wireless communication service who has subscribed to a different type of service. For example, as mentioned before a UMTS service generally is a premium service relative to a GSM service. However, GSM subscribers may be able to access the UMTS service without purchasing the premium UMTS subscription by inserting their GSM subscriber identity module (SIM) card (signifying their GSM service subscription) in a UMTS mobile device. Such GSM subscribers may be restricted from accessing the UMTS service, in accordance with an aspect of the invention. Conversely, UMTS subscribers may be restricted from accessing the GSM service to not overburden a limited GSM capacity, in accordance with another aspect of the invention.

In implementing the invention, when a request from a mobile device for accessing a wireless communication service (e.g., a location update request) is received via a communication facility, which is provisioned in accordance with a selected type of wireless communication service, authentication data (e.g., the aforementioned authentication vector) associated with the mobile device is obtained. In accordance with the invention, one or more restrictions may be imposed on the mobile device after it is determined that a presentation of the authentication data does not conform to the selected type of wireless communication service, for example, its data format, number of parameters in an authentication vector, and/or bit lengths of the individual parameters, etc. not meeting the specification of the selected type of service. One such restriction illustratively imposed on the mobile device may be denying its access to the wireless communication service. Another restriction may be a roaming restriction pre-agreed upon between an operator of a home public land mobile network (PLMN) to which a subscriber belongs and that of a visitor PLMN to which his/her mobile device roams.

### BRIEF DESCRIPTION OF THE DRAWINGS

FIG. 1 is a block diagram of a mobile communication system according to an illustrative embodiment of the invention;

FIG. 2 is a flow chart depicting an authentication process according to the GSM standard which is used in the system of FIG. 1;

FIG. 3 is a flow chart depicting an authentication process according to the UMTS standard which is used in the system of FIG. 1;

FIG. 4 is a flow chart depicting a process for restricting access to a UMTS service provided by the system of FIG. 1;

FIG. 5 is a block diagram of a mobile communication system according to a second illustrative embodiment of the invention; and

FIG. 6 is a flow chart depicting a process for restricting access to a GSM service provided by the system of FIG. 5.

### DETAILED DESCRIPTION

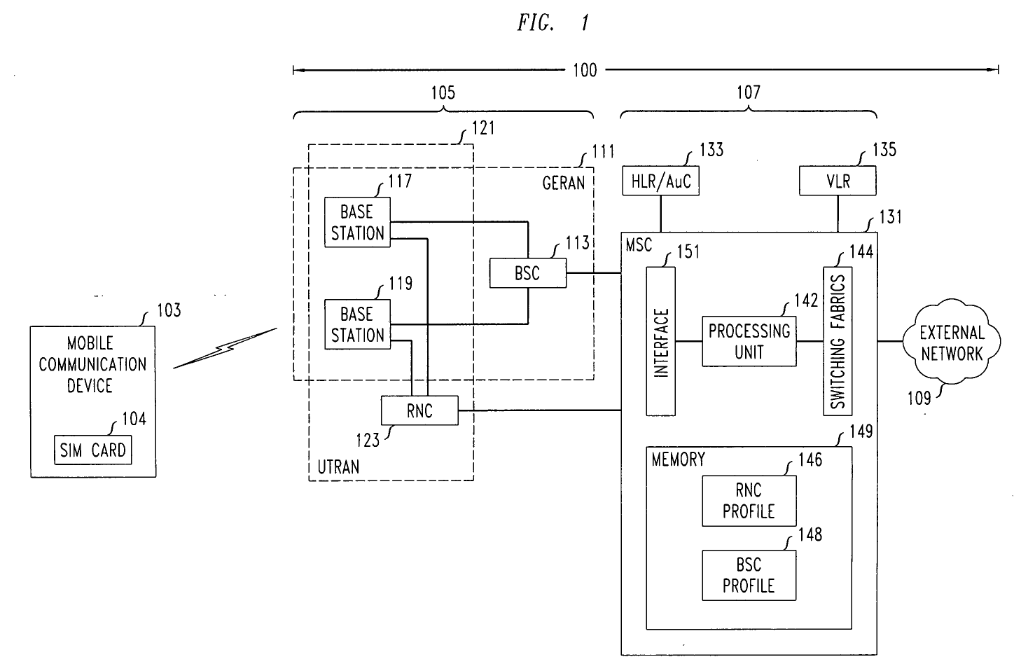

FIG. 1 illustrates wireless communication system 100 embodying the principles of the invention, and a representative mobile communication device, denoted 103. Device 103 may be a mobile phone, smart phone, iPhone®, personal digital assistant (PDA), Blackberry®-type device, Kindle™-type device, notebook or netbook computer, pocket personal computer (PPC), hand-held or portable device, etc. which is capable of wireless communications, and which may be incorporated in a system in a vehicle or mobile environment, e.g., in a car, airplane, etc. A subscriber may use device 103 to access a wireless communication service provided by system 100 through radio access network (RAN) subsystem 105. System 100 in this instance provides two types of wireless communication service, which may be, e.g., GSM and UMTS services. However, in accordance with the invention, a subscriber using device 103 may be denied the UMTS service provided by system 100 if it is determined that the subscriber has subscribed only to the GSM service. Conversely, a subscriber using device 103 may be denied the GSM service provided by system 100 if it is determined that the subscriber has subscribed only to the UMTS service. The actual service subscription may be identified by the type of a subscriber identity module (SIM) card 104, which needs to be inserted in device 103 when used. As is well known, a GSM SIM card comprises a portable memory chip which contains hard-coded personal GSM subscription and authentication information. As is also well known, a UMTS SIM (USIM) is realized as an application run on a UMTS IC card (UICC), a smart card. The USIM contains functions and data needed to identify and authenticate the associated mobile communication device to the UMTS service.

Core network subsystem 107 administers the mobile communication services and is capable of establishing and maintaining a communication, e.g., by device 103 through external network 109, e.g., a public switched telephone network (PSTN), internet protocol (IP) network, microwave network, satellite network, cable network, optical fiber network, etc., or a combination thereof.

In this illustrative embodiment, RAN subsystem 105 includes wireless facilities and channels for a GSM/EDGE radio access network (GERAN) and UMTS terrestrial radio access network (UTRAN), thereby supporting radio accesses to both the GSM and UMTS services. The GERAN part of subsystem 105, denoted 111, illustratively includes base station controller (BSC) 113 which, among other things, controls operations of base stations 117 and 119 in a well known manner to carry out the GSM service. Each of base stations 117 and 119 establishes physical radio connections, e.g., with device 103 accessing a wireless communication service. The UTRAN part of subsystem 105, denoted 121, illustratively includes radio network controller (RNC) 123 which, among others things, controls operations of base stations 117 and 119 in a well known manner to carry out the UMTS service. Base stations 117 and 119 may also be known as nodes B according to the UMTS standard.

Core network subsystem 107 illustratively includes mobile switching center (MSC) 131, home location register/authentication center (HLR/AuC) 133 and visited location register (VLR) 135. Processing unit 142 in MSC 131 is responsible for, among other things, originating and terminating a circuit switched connection between a mobile communications device (e.g., device 103) and another device via external network 109. For example, processing unit 142 performs switching and signaling functions through switching fabrics 144 to establish communication connections for subscribers in the service area associated with MSC 131. In this instance, it also controls radio resources for the UMTS service in accordance with RNC profile 146, and for the GSM service in accordance with a BSC profile 148. Both profiles 146 and 148 are stored and maintained in memory 149. Also installed in memory 149 may be service access restriction software (described below) for restricting a subscriber from using a service to which he/she is not subscribed, in accordance with some embodiments of the invention.

HLR/AuC 133 includes a conventional HLR and AuC which are associated with each other and in this instance are implemented in the same physical node. The HLR comprises a database for management of subscribers to the instant UMTS/GSM services. As is well known, the HLR contains international mobile subscriber identities (IMSIs) of the service subscribers which are used as keys to access other information about the subscribers and their subscription. Such other information includes billing information, information concerning subscribed service features, roaming limitations, authentication information, etc. Together with VLR 135, the HLR also handles mobility management. For example, to route and charge calls, the HLR maintains information concerning the VLR with which a subscriber currently in the location area (LA) associated with the VLR is registered. The AuC contains data needed for authentication and ciphering to maintain service integrity for each subscriber. VLR 135 contains a copy of data from the HLR and other data for properly providing a wireless communication service to each subscriber currently visiting the LA associated with VLR 135. Specifically, VLR 135 contains the subscriber's mobile device identity and authentication-related data, last known LA of the device, power class and other physical attributes of the device, a list of special services available to the subscriber, etc.

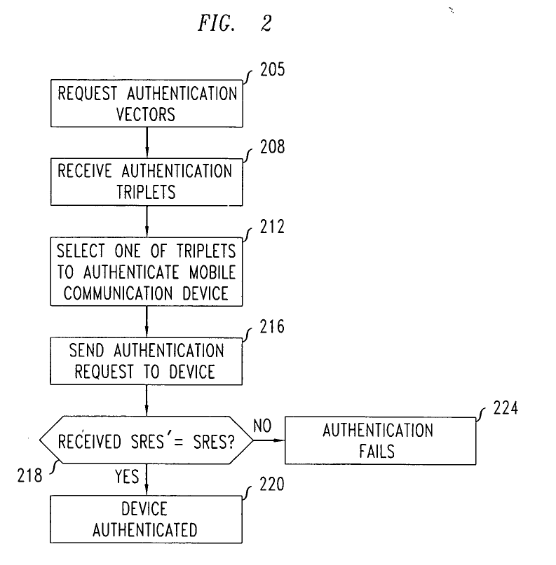

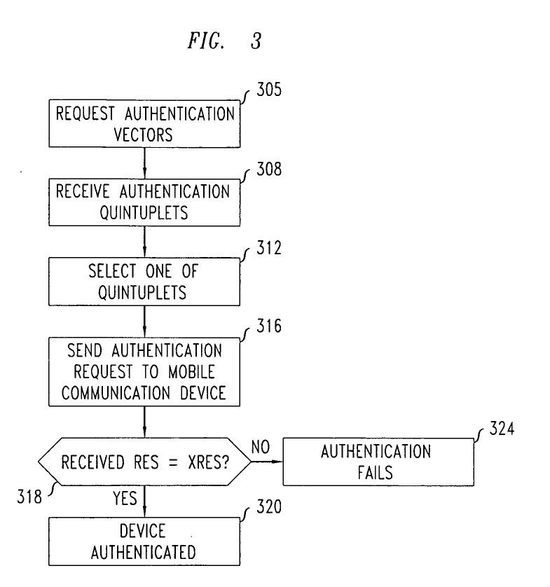

It should be noted at this point that various embodiments involve use of a certain authentication vector or parameters, occasioned by an authentication process in providing the instant GSM/UMTS service, to determine the actual service (GSM or UMTS service) subscribed by a subscriber. For example, when a mobile communication device (e.g., device 103) is turned on in the LA associated with VLR 135, the device needs to register with system 100. The authentication process involving the device may be initiated during one such registration. To better appreciate these embodiments, a conventional GSM authentication process and UMTS authentication process will now be described, with the aid of FIGS. 2 and 3, respectively.

Referring to FIG. 2, processing unit 142 in MSC 131 may perform the conventional GSM authentication process when device 103 registers with the GSM service part of system 100. Based on the information identifying device 103 during the registration, processing unit 142 at step 205 requests from HLR/AuC 133 multiple distinct authentication vectors (RAND, SRES, Kc) associated with device 103, where RAND represents a random challenge which is a 128-bit random number generated in the AuC; SRES represents a 32-bit signed result from using a secret key Ki signing the RAND; and Kc represents a 64-bit ciphering key used as a session key to initiate an encryption algorithm (conventionally known as A5) for encrypting the over-the-air radio communications between device 203 and a base station. The secret key Ki is shared between device 103 and HLR/AuC 133. Specifically, a copy of Ki is stored in SIM card 104 (a GSM SIM card in this instance), and the other copy in the AuC. The ciphering algorithm for signing the RAND with the secret key Ki to generate SRES is conventionally known as A3. Thus, in short SRES=A3(RAND, Ki). The session key Kc is computed by the AuC applying a ciphering algorithm (conventionally known as A8) to the RAND and secret key Ki, i.e., Kc=A8(RAND, Ki). Because of the fact that a GSM authentication vector contains three parameters, i.e., RAND, SRES and Kc, it is oftentimes referred to as an “authentication triplet.”

At step 208, processing unit 142 receives the requested authentication triplets, and stores them in VLR 135. At step 212, processing unit 142 selects one of the received authentication triplets to authenticate mobile communication device 103. At step 216, processing unit 142 sends an authentication request, including the RAND parameter in the selected triplet, to device 103.

Once device 103 receives the RAND from processing unit 142, device 103 computes SRES′=A3(RAND, Ki), where the shared secret key Ki is from SIM card 104. Device 103 sends its computed SRES′ to MSC 131.

Upon receiving the SRES′ in MSC 131, processing unit 142 at step 218 determines whether the received SRES′ is identical to the SRES from the previously selected authentication triplet. If they are identical, device 103 is deemed to be authenticated, as indicated at step 220. Otherwise, the authentication fails, as indicated at step 224.

Referring to FIG. 3, processing unit 142 in MSC 131 may perform the conventional UMTS authentication process when device 103 registers with the UMTS service part of system 100. Based on the information identifying device 103 during the registration, processing unit 142 at step 305 requests from HLR/AuC 133 multiple distinct authentication vectors (RAND, XRES, AUTN, CK, IK) associated with device 103, where RAND represents a random challenge which is a random number generated in the AuC; XRES represents an expected response by a USIM in device 103 to the random challenge; AUTN represents an authentication token that authenticates the AuC towards the USIM; CK represents a cipher key for confidentiality; and IK represents an integrity key for integrity checking. Because of the fact that a UMTS authentication vector contains five parameters, i.e., RAND, XRES, AUTN, CK and IK, it is oftentimes referred to as an “authentication quintuplet.”

It should be noted at this point that the AuC stores a secret key K, shared between device 103 and the HLR/AuC 133. Specifically, a copy of the secret key K is stored in SIM card 104 (a UICC in this instance), and the other copy in the AuC. In addition, the AuC stores such well known message authentication and key generating functions, f0-f5, according to the UMTS standard. In fact, some of the above authentication parameters may be expressed using these functions, namely, XRES=f2(K, RAND), CK=f3(RAND), and IK=f4(RAND).

At step 308, processing unit 142 receives the requested authentication quintuplets, and stores them in VLR 135. At step 312, processing unit 142 selects one of the received authentication quintuplets. At step 316, processing unit 142 sends an authentication request, including the RAND and AUTN parameters in the selected quintuplet, to mobile communication device 103.

Once device 103 receives the RAND from processing unit 142, in a well known manner the USIM in device 103 verifies the received AUTN to authenticate system 100, and computes a response RES=f2(K, RAND) based on the shared secret key K in SIM card 104 and the received RAND. Device 103 sends its computed RES to MSC 131.

Upon receiving the RES in MSC 131, processing unit 142 at step 318 determines whether the received RES is identical to the XRES from the previously selected authentication quintuplet. If they are identical, device 103 is deemed to be authenticated, as indicated at step 320. Otherwise, the authentication fails, as indicated at step 324.

After the UMTS authentication, MSC 131 sends the parameters CK and IK in the previously selected authentication quintuplet to RNC 123 for ciphering and integrity checking of communications by device 103.

In general, a UMTS service is a premium service relative to a GSM service because the UMTS service can afford better voice and data communications than the GSM service, and video communications (e.g., video conferencing) which the GSM service lacks. Some embodiments are premised upon the recognition that GSM subscribers may be able to access a UMTS service without purchasing the premium UMTS subscription by inserting their GSM SIM card (signifying their GSM service subscription) in UMTS equipment. In accordance with one such embodiment, such GSM subscribers (with GSM SIM cards) are restricted from accessing the UMTS service part of system 100. To that end, RNC profile 146 in MSC 131 is provisioned with an option of “GSM SIM restricted from UTRAN access” (“GSM SIM restriction” in short) which is selected in this illustrative embodiment.

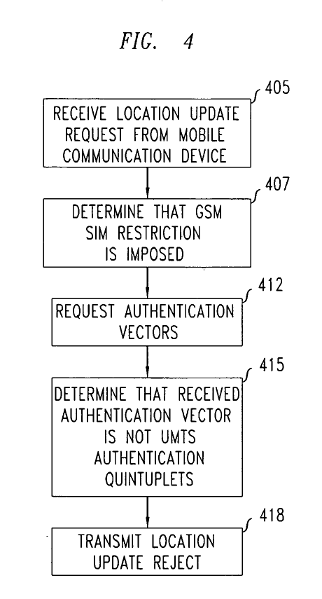

To demonstrate this embodiment, let's assume that mobile communication device 103 is UMTS equipment in which a GSM subscriber has inserted a GSM SIM card as card 104. When device 103 roams to an LA serviced by system 100 from another LA outside system 100, device 103 attempts to register onto MSC 131 via UTRAN 121. Accordingly, processing unit 142 in MSC 131 receives from mobile communication device 103, via UTRAN 121 and interface 151 in MSC 131, a location update request including information identifying device 103, as indicated at step 405 in FIG. 4. Processing unit 142 at step 407 determines that the GSM SIM restriction in RNC profile 146 is imposed in this instance. Knowing that the location update request came from RNC 123 in UTRAN 121, processing unit 142 at step 412 requests from HLR/AuC 133 authentication vectors associated with device 103 based on the received device identifying information. After receiving at least one authentication vector from HLR/AuC, processing unit 142 at step 415 determines that in this instance the received authentication vector associated with device 103 is not a UMTS authentication quintuplet. Rather, the received authentication vector actually is a GSM authentication triplet because of the subscriber's GSM subscription. Processing unit 142 can identify a UMTS authentication quintuplet by its data presentation including, but not limited to, its data format, the number of individual parameters (i.e., five) therein, and/or bit lengths of the individual parameters, pursuant to the UMTS standard. In accordance with this embodiment, processing unit 142 at step 418 transmits a location update reject to device 103 in response to its outstanding location update request. When the location update request by device 103 is rejected due to the GSM restriction, the cause of the rejection given to device 103 may be unavailability of suitable cells in the new LA. Accordingly, device 103 marks the new LA as unusable. However, this cause of rejection is for illustrative purposes only. It will be appreciated that those skilled in the art may provision RNC profile 146 with other causes of rejection to meet their particular application needs. It should also be noted that software instructions for the routine described in FIG. 4 may be stored in memory 149 of FIG. 1.

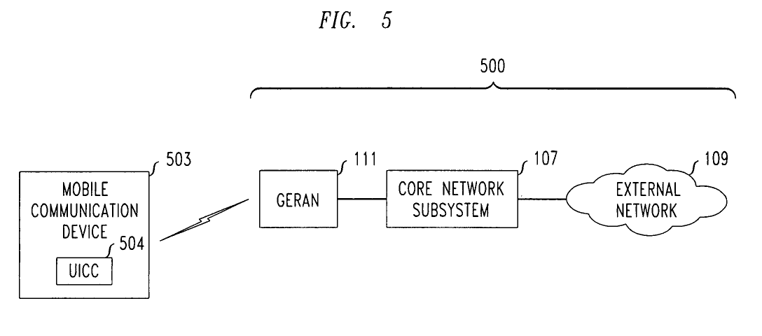

In a second embodiment of the invention, let's assume wireless communication system 100 only provides the GSM service, thus without the UMTS service. FIG. 5 illustrates such a version of system 100 in this second embodiment which is denoted 500. Like system 100, wireless communication system 500 in this instance provides access to the GSM service via GERAN 111, and includes core network subsystem 107 and external network 109 described before. However, unlike system 100, system 500 does not include any UTRAN provisions and, in particular, RNC profile 146 is no longer provisioned in subsystem 107 of system 500. Let's also assume that in this second embodiment that mobile communication device 503 in FIG. 5 is dual mode equipment, operating pursuant to both the GSM and UMTS standards, in which a UMTS subscriber has inserted UICC 504 on which a USIM runs. In addition, in this instance BSC profile 148 in MSC 131 of subsystem 107 is provisioned with an option of “USIM restricted from GERAN access” (“USIM restriction” in short) which is selected. This restriction may be imposed to prohibit a UMTS subscriber from utilizing an inferior GSM service, given the fact that the subscriber has paid for a premium UMTS service subscription. Other reasons for the restriction may be that system 500 currently is serving GSM subscribers at its full capacity and cannot be overburdened by serving additional UMTS subscribers.

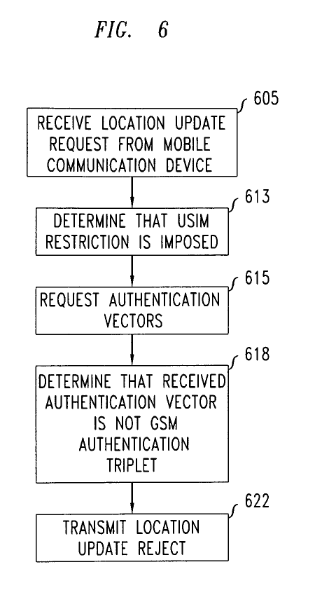

When device 503 roams to an LA serviced by system 500 from another LA outside system 500, device 503 attempts to register onto MSC 131 in subsystem 107 via GERAN 111. Accordingly, processing unit 142 in MSC 131 receives from device 503, via GERAN 111 and interface 151 in MSC 131, a location update request including information identifying device 503, as indicated at step 605 in FIG. 6. Processing unit 142 at step 613 determines that the USIM restriction in BSC profile 148 is imposed in this instance. Knowing that the location update request came from BSC 113 in GERAN 111, processing unit 142 at step 615 requests from HLR/AuC 133 authentication vectors associated with device 503 based on the received device identifying information. After receiving at least one authentication vector from HLR/AuC 133, processing unit 142 at step 618 determines that in this instance the received authentication vector associated with device 503 is not a GSM authentication triplet. Rather, the received authentication vector actually is a UMTS authentication quintuplet because of the subscriber's UMTS subscription. Processing unit 142 can identify a GSM authentication triplet by its presentation including, but not limited to, its data format, the number of individual parameters (i.e., three) therein, and/or bit lengths of the individual parameters, pursuant to the GSM standard. In accordance with this embodiment, processing unit 142 at step 622 transmits a location update reject to device 503 in response to its outstanding location update request. When the location update request by device 503 is rejected due to the USIM restriction, the cause of the rejection given to device 503 may be unavailability of suitable cells in the new LA. Accordingly, device 503 marks the new LA as unusable. Again, this cause of rejection is for illustrative purposes only. It will be appreciated that those skilled in the art may provision BSC profile 148 with other causes of rejection to meet their particular application needs. It should also be noted that software instructions for the routine described in FIG. 6 may be stored in memory 149 of subsystem 107.

The foregoing merely illustrates the principles of the invention. It will thus be appreciated that those skilled in the art will be able to devise numerous arrangements which embody the principles of the invention and are thus within its spirit and scope.

For example, in system 100 where both UMTS and GSM services are provided, even though only the GSM SIM restriction is imposed in the illustrative embodiment, it will be appreciated that the above-described USIM restriction may also be imposed if so desired.

In addition, in the embodiments of the invention, the GSM SIM and USIM restrictions are provisioned in an MSC (e.g., 131) for administering circuit switched connections. However, the invention is applicable not only in a circuit switched environment, but also a packet switched environment or other voice/data/video transport environments. For example, for the data service, the GSM SIM and USIM restrictions in accordance with the invention may be provisioned on a well known serving general packet radio service (GPRS) support node (SGSN), analogous to the MSC.

Moreover, in another embodiment of the invention, an MSC or SGSN can selectively enforce the above-described access restrictions and/or other restrictions based on the IMSI of a subscriber, which contains an identification of the home public land mobile network (PLMN) to which the subscriber belongs. In that embodiment, when the subscriber's mobile communication device roams to a visitor PLMN, and the MSC or SGSN of the visitor PLMN determines an authentication vector discrepancy, e.g., from step 415 of FIG. 4 or step 618 of FIG. 6, the MSC or SGSN may further check the IMSI in the SIM of the roaming device for the identification of its home PLMN. Depending on a prior agreement between operators of the home PLMN and visitor PLMN, the MSC or SGSN may selectively impose upon the roaming device an access restriction described above and/or other roaming restrictions.

Further, although in the disclosed embodiments a mobile communication device (e.g., 103) accesses a wireless communication service (e.g., UMTS, GSM, etc.) through an RNC or BSC via a radio access network (RAN), it will be appreciated that the device may access the same wireless communication service via a wired connection (e.g., web connection) to the RNC or BSC. For example, it is envisioned that in one such web connection arrangement, a mobile communication device may be wirelessly connected to the web, e.g., via Wi-Fi or other wireless LAN in a home, cafe, airport, Wi-Fi “hot zone,” etc.

Finally, although wireless communication systems 100 and 500 are embodied in the form of various discrete functional blocks, these systems could equally well be embodied in an arrangement in which the functions of any one or more of those blocks or indeed, all of the functions thereof, are realized, for example, by one or more appropriately programmed processors or devices.

What is claimed is:

1. A system for providing at least one selected type of wireless communication service, comprising:
an interface for receiving, via a communication facility, a request from a mobile device for accessing a wireless communication service, the communication facility being provisioned in accordance with the selected type of wireless communication service; and
a processing element configured to obtain authentication data associated with the mobile device based on selected information in the request, wherein one or more restrictions are imposed on the mobile device after it is determined that a presentation of the authentication data does not conform to the selected type of wireless communication service.

2. The system of claim 1 comprising a mobile switching center (MSC).

3. The system of claim 1 comprising a serving general packet radio service (GPRS) support node (SGSN).

4. The system of claim 1 wherein the at least one selected type of wireless communication service includes a service in accordance with a global system for mobile communications (GSM) standard.

5. The system of claim 1 wherein the at least one selected type of wireless communication service includes a service in accordance with a universal mobile telecommunication system (UMTS) standard.

6. The system of claim 1 wherein the communication facility includes at least one wireless channel.

7. The system of claim 1 wherein the authentication data includes at least part of an authentication vector pursuant to the GSM standard.

8. The system of claim 1 wherein the authentication data includes at least part of an authentication vector pursuant to the UMTS standard.

9. The system of claim 1 wherein the presentation of the authentication data includes a format thereof.

10. The system of claim 1 wherein the one or more restrictions include denying access by the mobile device to the wireless communication service.

11. A system for providing at least one selected type of wireless communication service, comprising:
a communication facility configured in accordance with the selected type of wireless communication service through which a communication from a mobile device is received, data for authentication of at least the mobile device being obtained based on selected information in the communication; and
a processing element configured to determine whether a presentation of the authentication data conforms to the selected type of wireless communication service, wherein access by the mobile device to the selected type of wireless communication service provided by the system is denied after it is determined that a presentation of the authentication data does not conform to the selected type of wireless communication service.

12. The system of claim 11 wherein the at least one selected type of wireless communication service includes a service in accordance with a GSM standard.

13. The system of claim 11 wherein the at least one selected type of wireless communication service includes a service in accordance with a UMTS standard.

14. The system of claim 11 wherein the communication facility includes at least one wireless channel.

15. The system of claim 11 wherein the authentication data includes at least part of an authentication vector pursuant to the GSM standard.

16. The system of claim 11 wherein the authentication data includes at least part of an authentication vector pursuant to the UMTS standard.

17. The system of claim 11 wherein the presentation of the authentication data includes a format thereof.

18. A method for use in a system for providing at least one selected type of wireless communication service, comprising:
receiving, via a communication facility, a request from a mobile device for accessing a wireless communication service, the communication facility being provisioned in accordance with the selected type of wireless communication service;
obtaining authentication data associated with the mobile device based on selected information in the request;
determining whether a presentation of the authentication data conforms to the selected type of wireless communication service; and
imposing one or more restrictions on the mobile device after it is determined that a presentation of the authentication data does not conform to the selected type of wireless communication service.

19. The method of claim 18 wherein the at least one selected type of wireless communication service includes a service in accordance with a GSM standard.

20. The method of claim 18 wherein the at least one selected type of wireless communication service includes a service in accordance with a UMTS standard.

21. The method of claim 18 wherein the authentication data includes at least part of an authentication vector pursuant to the GSM standard.

22. The method of claim 18 wherein the authentication data includes at least part of an authentication vector pursuant to the UMTS standard.

23. The method of claim 18 wherein the presentation of the authentication data includes a format thereof.

24. The method of claim 18 wherein the one or more restrictions include denying access by the mobile device to the wireless communication service.
